(19) United States
(12) Patent Application Publication
(10) Pub. No.: US 2018/0303306 A1
(43) Pub. Date: Oct. 25, 2018

(54) MUSICAL CLEANING DEVICE HAVING MULTIPLE CLEANING COMPONENTS

(71) Applicant: Mya Lana Johnson, Atlantis, FL (US)

(72) Inventor: Mya Lana Johnson, Atlantis, FL (US)

(21) Appl. No.: 15/695,872

(22) Filed: Sep. 5, 2017

Related U.S. Application Data
(60) Provisional application No. 62/488,234, filed on Apr. 21, 2017.

(51) Int. Cl. A47L 13/20; A47L 13/50; G10H 1/00

(52) U.S. Cl. CPC A47L 13/20; G10H 2240/251; G10H 1/0083; A47L 13/50

(57) ABSTRACT

An entertainment enabled cleaning device, referred to generally as a musical cleaning device. The musical cleaning device, illustrated herein as a mop, comprises a main body, illustrated herein as an elongated rod. The main body has a first end and a second opposing end. Removably attached to the first end is an entertainment member. Attached to the second end is a cleaning member. The main body may also contain an extension member, allowing the length of the main body to expand, and lock in place, if desired. The entertainment member is configured wirelessly communicate with an electronic device, such as a smart phone. Accordingly, the musical mop can be used to 1) play music loaded onto the electronic device, and/or 2) use the electronic device to receive telephone calls through the musical mop.

### PRIORITY CLAIM

In accordance with 37 C.F.R. 1.76, a claim of priority is included in an Application Data Sheet filed concurrently herewith. Accordingly, the present invention claims priority to U.S. Provisional Patent Application No. 62/488,234, entitled “MUSICAL CLEANING DEVICE HAVING MULTIPLE CLEANING COMPONENTS”, filed Apr. 21, 2017. The contents of the above referenced application are incorporated herein by reference.

### FIELD OF THE INVENTION

The present invention relates to a cleaning device; and more particularly, to a mop that receives and plays music.

### BACKGROUND OF THE INVENTION

Cleaning devices, such as mops, are known in the art. Such cleaning devices are designed to clean a variety of surfaces, such as floors, including wood floors, tile floors, laminate floors, or other surfaces that are in need of cleaning. Typical mops include a body with a cleaning end adapted to clean a surface and a manipulating end adapted to allow a user to move the cleaning device around.

Cleaning floors and other surfaces is required to ensure homes or businesses remain free from a build up of bacteria, dust or allergens. While maintaining a clean home or business is generally for aesthetic purposes, those spending time within an unclean area risk developing health problems. Although a necessary action, cleaning floors or other surfaces can be mundane and not enjoyable.

Often times, buildings have many different surfaces which require different cleaning units. Having to use multiple cleaning devices specific for a job or surface makes the cleaning process more difficult. Requiring cleaning personnel to have on hand and use many different devices adds time to each cleaning job, and requires cleaning personnel to drag all the necessary equipment from job to job.

What is needed in the art, therefore, is a cleaning device that is adapted to clean multiple surfaces using multiple cleaning components. In addition, a cleaning device that makes the cleaning process more enjoyable would be desired.

### SUMMARY OF THE INVENTION

The present invention relates to an improved cleaning device with entertainment or independent electronic device communication capability. The entertainment enabled cleaning device is adaptable to clean multiple surfaces using multiple cleaning members. In addition, the cleaning device is configured to provide at least one source of entertainment to a user.

In one embodiment, the cleaning device is a cleaning mop. The musical cleaning mop comprises a main body, illustrated herein as an elongated rod. The main body has a first end and a second opposing end. Attached to the first end is an entertainment member. Attached to the second end is a cleaning member. The main body may also contain an extension member, allowing the length of the main body to expand, and lock in place, if desired. The entertainment member is configured to wirelessly communicate with an electronic device, such as a smart phone. Accordingly, the musical mop can be used to 1) play music loaded onto the electronic device, and/or 2) use the electronic device to receive telephone calls through the musical mop.

Accordingly, it is an objective of the invention to provide an enhanced cleaning device.

It is a further objective of the invention to provide an improved cleaning device configured to clean one or more surfaces using multiple cleaning heads.

It is yet another objective of the invention to provide an entertainment enabled cleaning device.

It is a still further objective of the invention to provide an improved, entertainment enabled cleaning device configured to clean one or more surfaces using multiple cleaning heads.

It is a further objective of the invention to provide an entertainment enabled cleaning device that communicates with an electronic device.

It is yet another objective of the invention to provide an entertainment enabled cleaning device that communicates with an electronic device using wireless communication technology.

It is a still further objective of the invention to provide an improved, entertainment enabled cleaning device configured to clean one or more surfaces using multiple cleaning heads, and which communicates with an electronic device, preferably using wireless communication technology.

It is a further objective of the invention to provide an improved cleaning mop configured to clean one or more surfaces using multiple cleaning heads.

It is yet another objective of the invention to provide an entertainment enabled cleaning mop.

It is a still further objective of the invention to provide an improved, entertainment enabled cleaning mop configured to clean one or more surfaces using multiple cleaning heads.

It is a further objective of the invention to provide an entertainment enabled cleaning mop that communicates with an electronic device.

It is yet another objective of the invention to provide an entertainment enabled cleaning mop that communicates with an electronic device using wireless communication technology.

It is a still further objective of the invention to provide an improved, entertainment enabled cleaning mop configured to clean one or more surfaces using multiple cleaning heads which communicates with an electronic device, preferably using wireless communication technology.

It is another objective of the invention to provide a musical mop configured to be used to play music loaded onto an electronic device, such as a smart phone, through the musical mop.

It is a still further objective of the invention to provide a musical mop configured to use an electronic device, such as a smart phone, to receive (and talk) telephone calls through the musical mop.

It is a still further objective of the invention to provide a musical mop configured to act as an interactive entertainment or video device.

It is a still further objective of the invention to provide a musical mop configured to act as an interactive entertainment device in which an individual can sing into a detachable microphone.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE FIGURES

FIG. 1 is a perspective view of an illustrative example of a musical mop;

FIG. 2 is an exploded view of the musical mop;

FIG. 3 illustrates the musical mop system, showing multiple cleaning head attachments;

FIG. 4 is a schematic diagram illustrating the internal functioning components;

FIG. 5 is a perspective view of an external connecting device; and

FIG. 6 illustrates the external connecting device attached to a mobile smart device.

### DETAILED DESCRIPTION OF THE INVENTION

While the present invention is susceptible of embodiment in various forms, there shown in the drawings and will hereinafter be described a presently preferred, albeit not limiting, embodiment with the understanding that the present disclosure is to be considered an exemplification of the present invention and is not intended to limit the invention to the specific embodiments illustrated.

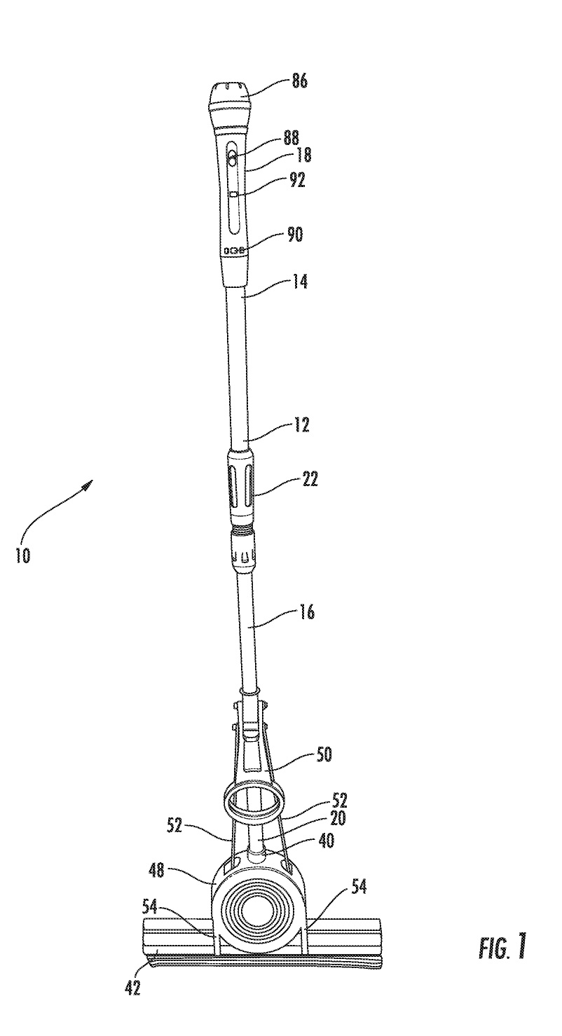

Referring, to FIG. 1, an illustrative, entertainment enabled cleaning device, referred to generally as a musical cleaning device 10 is shown. The musical cleaning device 10 is illustrated herein as a mop. Accordingly, the use of the terms “musical cleaning device 10” and “musical mop 10” may be used interchangeably. The musical mop 10 comprises a main body 12, illustrated herein as an elongated rod. The main body 12 has a first end 14 and a second opposing end 16. Attached to the first end 14 is an entertainment member 18. Attached to the second end 16 is a cleaning member 20. The main body 12 may also contain an extension member 22, allowing the length of the main body 12 to expand, and lock in place, if desired. Each one of the components, the main body 12, the entertainment member 18, and the cleaning member 20 may be made of one or more various materials such as plastics, including hard, high-impact plastic such as polypropylene, or acrylonitrile butadiene styrene (ABS), high-strength steel, such as stainless steel, or other materials as known to one of skill in the art.

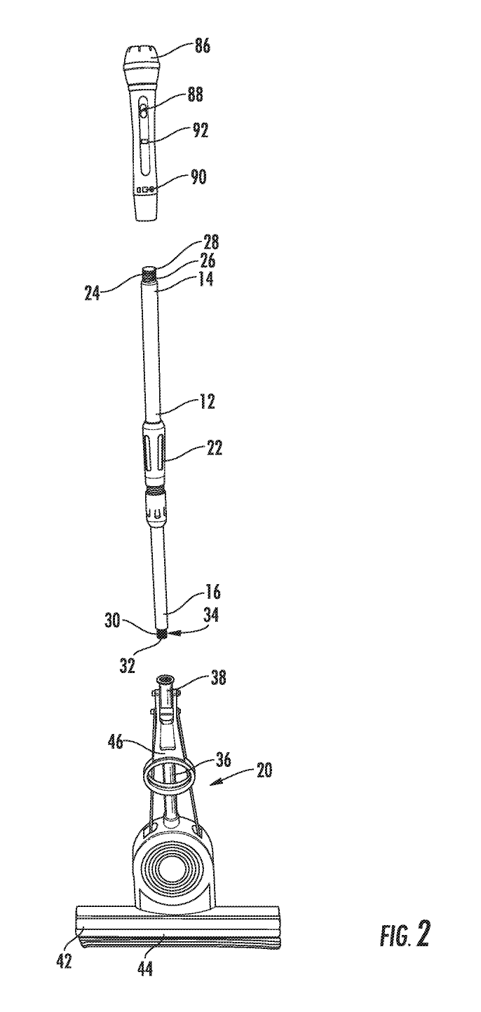

Referring to FIG. 2, the main body 12 may comprise securing components at each end, first end 14 and second end 16, to secure at least a portion of the entertainment member 18 or the cleaning member 20. A first securing component 24 is illustrated as a cylindrical extension 26 having male threading 28 sized and shaped to interact and lock with corresponding entertainment member securing member, such as female threading (not shown). A second securing component 30 is illustrated as a cylindrical extension 32 having male threading 34 sized and shaped to interact and lock with or screw into a corresponding cleaning member securing member, such as female threading (not shown).

The cleaning member 20, illustrated in FIGS. 1 and 2, is that of a sponge mop member. The sponge mop member comprises a sponge mop main body 36, illustrated herein as a cylindrical rod, a first end (which forms the cleaning member securing member, which secures second securing member 30 form the musical mop 10) and a second end 40, which contains sponge mop 42. The sponge mop 42 may be a super absorbent cellulose sponge having rippling 44 designed for extra scrubbing purposes. A wringing lever system 46, having a housing 48, a lever 50, support bars 52, and linking bars 54, provides a wringing action mechanism to the super absorbent sponge mop 42 when needed. Activating the wringing lever system 46 applies a pressure to the sponge mop 42, squeezing any liquid the 42 may be holding out.

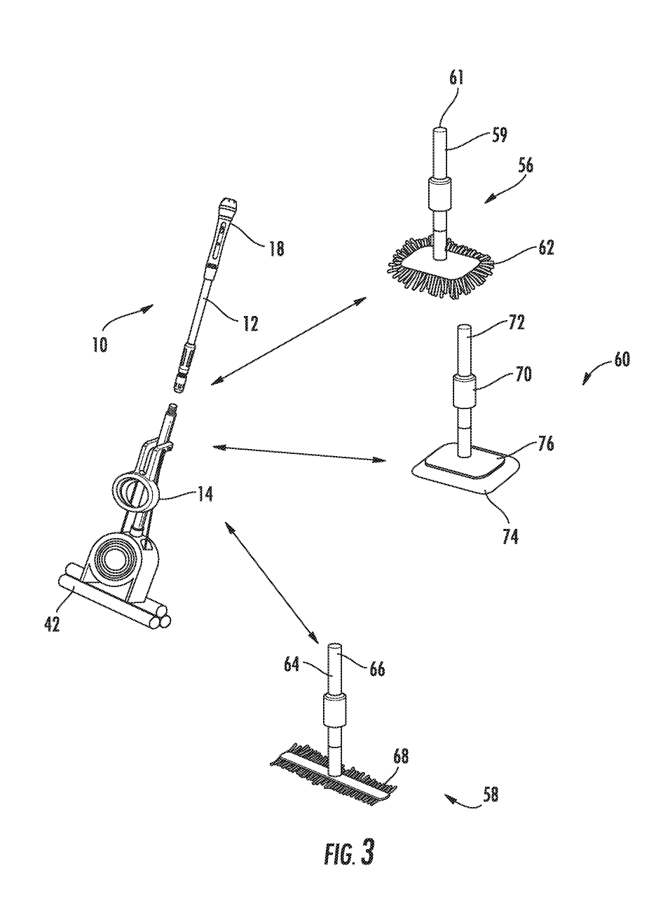

To provide greater functionality, the cleaning member 20 may be a cleaning unit other than a sponge mop 42. FIG. 3 illustrates the musical cleaning device 10 with several different cleaning member 20 attachment units. While the musical cleaning device 10 is shown with a sponge mop 42 attached, a circular mop head 56, a wet/dry mop head 58, or a microfiber mop head 60 may be used. The circular mop head 56 contains a main body 59, shown as a bar, with a securing end 61 configured (female threading, not shown) to secure to the second securing component of the musical mop main body 12. A plurality of looped cotton yarn 62 may provide for wet cleaning. Alternatively, a plurality of synthetic fibers, such as 4-ply polyrayon may be used for dry applications, such as for applying floor finish.

The wet/dry mop head 58 may contain a main body 64, shown as a bar, with a securing end 66 configured (female threading, not shown) to secure to the second securing component 30 of the musical mop main body 12. A plurality of looped cotton yarn 68 may provide for wet cleaning. Alternatively, a plurality of synthetic fibers, such as 4-ply polyrayon may be used for dry applications, such as for applying floor finish. The microfiber mop head 60 may contain a main body 70, shown as a bar, with a securing end 72 configured (female threading, not shown) to secure to the second securing component 30 of the musical mop main body 12. A microfiber cleaning material 74 secured to a support structure 76 provides a mechanism to allow the user to clean a surface with the microfiber material. While the circular mop head 56, the wet/dry mop head 58, and the microfiber mop head 60 are illustrated as possible cleaning head attachments, these examples are illustrative only. Other cleaning devices known one of skill in the art may be attached and utilized.

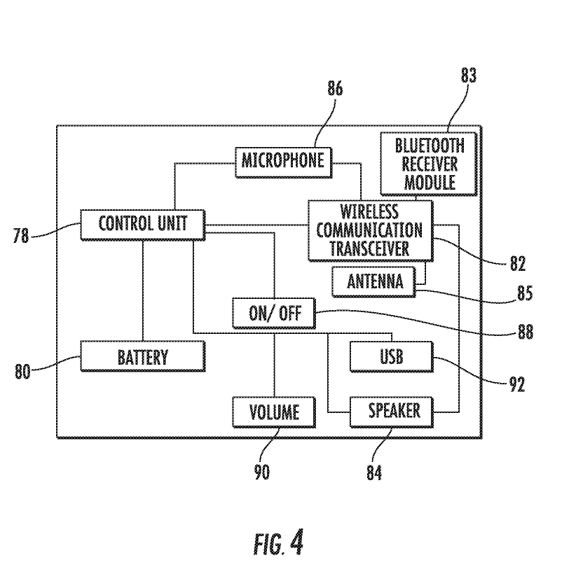

The entertainment member 18 is configured to house one or more functional components that allow the user to utilize musical mop 10 entertainment functions. FIG. 4 is a schematic diagram illustrating the internal functioning components. The entertainment member 18 preferably contains a control unit 78, such as a microprocessor (with memory if required) and/or an integrated circuit(s) (IC(s)). The IC(s) would preferably contain specific machine language code to enable the musical mop to work as required, as well as interface with other products. The entertainment member 18, preferably, has an independent power supply, such as a battery (lithium battery) 80. The entertainment member 18 provides a wireless communication functionality to implement wireless communication between the musical mop 10 and an electronic device over wireless communication link. The entertainment member 18, therefore, is detachable from the main body 12. The wireless communication allows a user to use the entertainment head 18 when not attached to the main body 12. In addition, a user could remove the entertainment head 18 associated with a first main body 12, and secure it to a second, different main body 12 of another musical mop 10. The electronic device may be any electronic device capable of transmitting data, such as a smart phone or smart tablet. A wireless communication transceiver 82 for emitting and/or receiving signals allows wireless communication, such as bi-directional communication, such as Bluetooth, between the two devices. The wireless communication transceiver 82 may include a Bluetooth receiver module 83 and/or antenna 85. Bluetooth technology is a short range, wireless communication technology which allows enabled devices to connect and communicate with each other via pairing, such as using secure simple paring (SSP).

Accordingly, the musical mop 10 may include a Bluetooth pairing mode, through which pairing between the Bluetooth receiver module and the external electronic device may be accomplished. Once the musical mop 10 and electronic devices are paired, the device may automatically connect when both devices are powered “on,” with Bluetooth enabled, and are in Bluetooth range. In some embodiments, the musical mop 10 may include a standby mode that may monitor for nearby Bluetooth enabled devices to which it has been paired, and may automatically power “on” fully when the paired device is in range. In some embodiments, where the paired device is transmitting audio, the musical mop 10 may also automatically begin playback received from the nearby device through the Bluetooth connection.

Using such wireless communication, the musical mop can be used to 1) play music loaded onto the electronic device, and/or 2) use the electronic device to receive telephone calls through the musical mop 10. To further aid in this functioning, the entertainment member 18 may contain a wired or wireless speaker 84 and a microphone 86. A plurality of input buttons, such as an on/off switch 88 or volume or mute buttons 90, may also be included. The entertainment member 18 may further include a standard cable connection interface 92, such as a USB (Universal Serial Bus) port, for transferring digital data between two devices over USB cables, or for powering the musical mop 10.

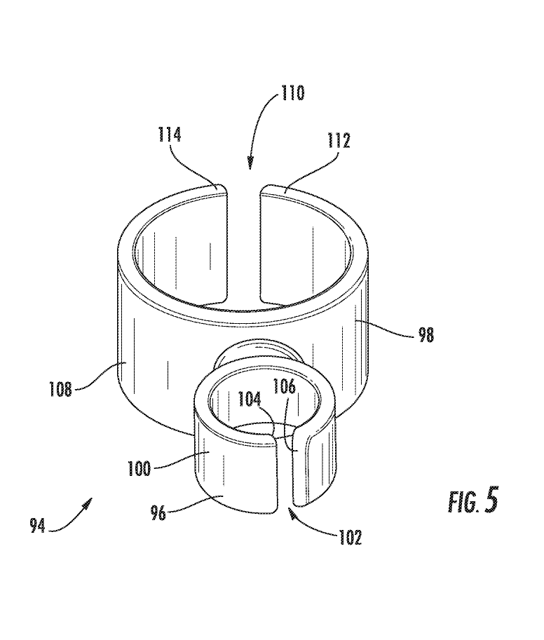

Since the musical mop 10 is wirelessly connected to the electronic device, the electronic device need not be hand held. A user may place the electronic device in his/her pocket. Alternatively, the musical mop 10 may contain an electronic device support structure 94, see FIG. 5, configured to attach to the musical mop 10. The electronic device support structure 94 contains a musical mop body securing portion 96 and an electronic device body securing portion 98. The musical mop body securing portion 96 contains a body 100 with space 102 separating arm 104 and arm 106. The body 100 is preferably made of a flexible or semi-flexible material so that, when a portion of the musical mop is inserted therein, the arms 104 and 106 separate and extend far enough to receive the musical mop and snap back into their original position, now pressing against the inserted musical mop.

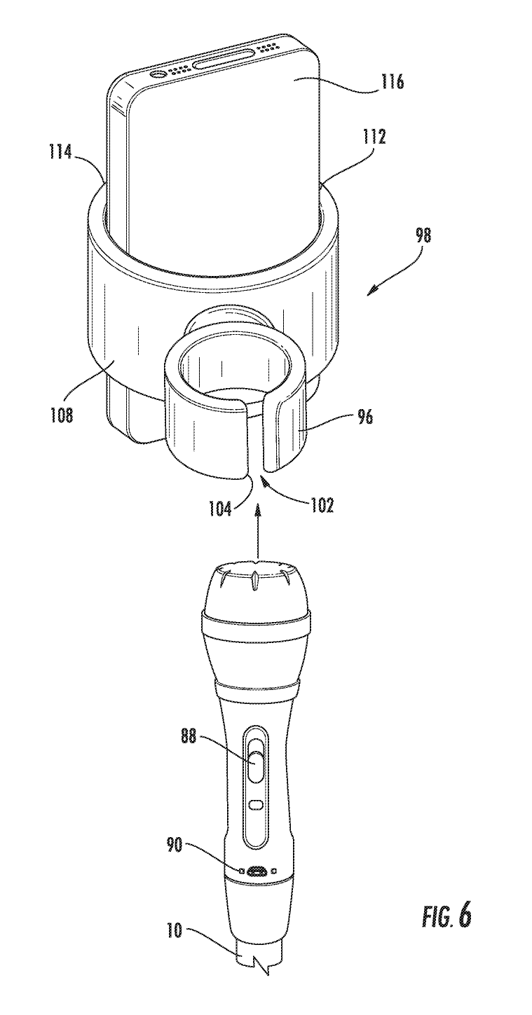

The electronic device body securing portion 98 contains a body 108 with space 110 separating arm 112 and arm 114. The body 108 is preferably made of a flexible or semi-flexible material so that, when a portion of the electrical device. Illustrated as a cell phone 116 (FIG. 6), is inserted therein, the arms 112 and 114 separate and extend far enough to receive the cell phone 116 and snap back into their original positioning, now pressing against the inserted cell phone 116.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, is not to be limited to the specific form or arrangement herein described and shown. Tt will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should be unduly limited to such specific embodiments. Indeed, various modifications of the described modes for carrying out the invention which are obvious to those skilled in the art are intended to be within the scope of the following claims.

What is claimed is:

1. An entertainment enabled cleaning device comprising:
a main body having a first end and a second opposing end;
an entertainment member configured to be secured to said main body first end; and
a cleaning member configured to be secured to said main body second end.

2. The entertainment enabled cleaning device according to claim 1 wherein said cleaning member comprises a first end configured to secure to said main body and a second end comprising a cleaning unit.

3. The entertainment enabled cleaning device according to claim 1 wherein said cleaning unit is a mop head.

4. The entertainment enabled cleaning device according to claim 3 wherein said mop head is made of an absorbent cellulose sponge material.

5. The entertainment enabled cleaning device according to claim 4 wherein said absorbent cellulose sponge material contains rippling.

6. The entertainment enabled cleaning device according to claim 1 wherein said cleaning unit is a circular mop head

7. The entertainment enabled cleaning device according to claim 1 wherein said cleaning unit is a wet or dry mop head.

8. The entertainment enabled cleaning device according to claim 1 wherein said cleaning unit is a microfiber mop head.

9. The entertainment enabled cleaning device according to claim 1 further including a lever system configured for applying a pressure to one or more components of said mop head.

10. The entertainment enabled cleaning device according to claim 1 wherein said entertainment member houses one or more functional components which allow said entertainment enabled cleaning device to communicate with an independent electronic device.

11. The entertainment enabled cleaning device according to claim 10 wherein communication with said independent electronic device is wireless.

12. The entertainment enabled cleaning device according to claim 11 wherein said wireless communication is Bluetooth.

13. The entertainment enabled cleaning device according to claim 10 wherein said independent electronic device is capable of transmitting data.

14. The entertainment enabled cleaning device according to claim 13 wherein said independent electronic device is a smart phone or smart tablet.

15. The entertainment enabled cleaning device according to claim 13, wherein said entertainment enabled cleaning device includes a Bluetooth pairing mode, wherein gaiting between said entertainment enabled cleaning device and said external electronic device may be accomplished.

16. The entertainment enabled cleaning device according to claim 1 wherein said entertainment member includes a removable microphone.

17. The entertainment enabled cleaning device according to claim 1 further including one or more input buttons.

18. The entertainment enabled cleaning device according to claim 1 further including one or more speakers.

19. The entertainment enabled cleaning device according to claim 1 further including an electronic device support structure.
